(19) United States
(12) Patent Application Publication
(10) Pub. No.: US 2018/0260066 A1
(43) Pub. Date: Sep. 13, 2018

(54) TOUCH SENSING DEVICE AND CONTROL METHOD THEREOF

(71) Applicant: PIXART IMAGING INC., HSIN-CHU (TW)

(72) Inventors: YU-HAN CHEN, Hsin-Chu (TW); HAN-SHU LIN, Hsin-Chu (TW); JUNG-TAI LIN, Hsin-Chu (TW)

(21) Appl. No.: 15/457,495

(22) Filed: Mar. 13, 2017

(51) Int. Cl. G06F 3/041; G06F 3/044

(52) U.S. Cl. CPC G06F 3/0416; G06F 3/044

(57) ABSTRACT

Provided herein are a sensing device and a control method thereof. The sensing device comprises a control unit, at least one first sensor and at least one fake sensor. The first sensor configured for detecting a touch event and generating a first sensing signal corresponding to an environmental change and an applied touch event, and sending the first sensing signal to the control unit. The fake sensor configured for generating a second sensing signal corresponding to the environmental change, and sending the second sensing signal to the control unit, wherein the control unit compensates the first sensing signal for the environmental change by using the second sensing signal and generates a compensated signal corresponding to the applied touch event. Accordingly, the present invention achieves the result of removing the influence of environmental changes for the sensing device.

### BACKGROUND OF THE INVENTION

### 1. Field of the Invention

The present invention relates to a touch sensing device and a control method thereof; in particular, to a touch sensing device for sensing object touched a sensing region and removing the influence of environmental changes, wherein the touch sensing device could be a capacitive sensing device.

### 2. Description of Related Art

Touch sensing devices are becoming increasingly popular because of their ease of use, versatility, and low price. A touch sensing device is often incorporated into electronic devices, such as portable computers or smart phones, and used as to implement a pointing device. The touch sensing device allows a user to move a cursor or induce a function by simply touching an input surface of the touch sensing device with a finger or a stylus. In general, the touch sensing device recognizes at least one of the location and pressure of the touch on the input surface and sends a signal to a processor. The processor performs actions according to the signal. There are different types of touch sensing devices, such as capacitive sensing panels, resistive sensing panels, surface acoustic wave sensing panels, infrared sensing panels, etc.

However, environmental changes, such as temperature, humidity or atmospheric pressure, can affect sensitivity of the sensing device, thus reducing the stability of the sensing device. Take the capacitive sensing panel for example, the capacitive sensing panel may be comprised of rows of a first set of conductive traces, and of columns of a second set of conductive traces, and a dielectric insulator. The first set of conductive traces and the second set of conductive traces are insulated by the dielectric insulator to form a grid with an array of capacitors. When a point on the sensing panel is touched, the capacitance of the capacitors at that point changes. A subsequent circuit then generates a signal according to the change of capacitance, and the signal can be used to identify the point.

As the environment changes, the coupling capacitance between the human body and the sensing panel changes, and the sensitivity of the sensing panel will be affected accordingly. Thus, changes in the environment may affect the stability of the sensing panel.

Therefore, a touch sensing device and a control method for removing the influence of environmental changes are desirable.

### SUMMARY OF THE INVENTION

The object of the present invention is to remove the influence of environmental changes for a touch sensing device by setting at least one fake sensor for a control unit to compensate for the influence of environmental changes, thereby ensuring the stability of the touch sensing device operation in various environments.

In order to achieve the aforementioned object, an embodiment of the present invention comprises a touch sensing device, comprising: a control unit, at least one first sensor coupled to the control unit, the first sensor configured for detecting a touch event and generating a first sensing signal corresponding to an environmental change and the touch event applied, and sending the first sensing signal to the control unit, and at least one fake sensor coupled to the control unit, the fake sensor configured for generating a second sensing signal corresponding to the environmental change, and sending the second sensing signal to the control unit, and wherein the control unit compensates the first sensing signal for the environmental change by using the second sensing signal and generates a compensated signal as an output signal corresponding to the touch event applied.

In order to achieve the aforementioned objects, another embodiment of the present invention comprises a method for controlling a touch sensing device, comprising: detecting a touch event and generating a first sensing signal corresponding to an environmental change and the touch event applied by a first sensor, sending the first sensing signal to a control unit, generating a second sensing signal corresponding to the environmental change by a fake sensor, sending the second sensing signal to the control unit, and compensating the first sensing signal for the environmental change by the second sensing signal and generating a compensated signal as an output signal corresponding to the touch event applied by the control unit.

In order to achieve the aforementioned object, still another embodiment of the present invention comprises a touch sensing device, comprising: a touching control unit, a touching sensor coupled to the touching control unit, the touching sensor configured for detecting a touch event and generating a touch sensing signal, and sending the touch sensing signal to the touching control unit, a temperature compensation unit coupled to the touching control unit, and a temperature detection unit coupled to the temperature compensation unit, the temperature detection unit configured for measuring the temperature of the touch sensing device and generating a temperature value, and sending the temperature value to the temperature compensation unit, wherein the temperature compensation unit generates a background response control signal corresponding to the temperature value and sends the background response control signal to the touching control unit, and the touching control unit adjusts the touch sensing signal according to the background response control signal.

In order to further the understanding regarding the present invention, the following embodiments are provided along with illustrations to facilitate the disclosure of the present invention.

### BRIEF DESCRIPTION OF THE DRAWINGS

FIG. 1 shows a schematic diagram of an electronic device according to one embodiment of the present invention;

FIG. 2 shows a block diagram of an electronic device according to one embodiment of the present invention;

FIG. 3 shows a schematic diagram of a touch sensing device according to another embodiment of the present invention;

FIG. 4 shows a block diagram of an electronic device according to another embodiment of the present invention;

FIG. 5 shows a schematic diagram of a touch sensing device according to still another embodiment of the present invention;

FIG. 6 shows a block diagram of an electronic device according to still another embodiment of the present invention;

FIG. 7 shows a flowchart of a method for controlling a touch sensing device according to one embodiment of the present invention; and

FIG. 8 shows a flowchart of a method for controlling a touch sensing device according to another embodiment of the present invention.

FIG. 9 shows a block diagram of an electronic device according to still another embodiment of the present invention.

FIG. 10 shows a block diagram of an electronic device according to still another embodiment of the present invention.

### DETAILED DESCRIPTION OF THE PREFERRED EMBODIMENTS

The aforementioned illustrations and following detailed descriptions are exemplary for the purpose of further explaining the scope of the present invention. Other objectives and advantages related to the present invention will be illustrated in the subsequent descriptions and appended drawings.

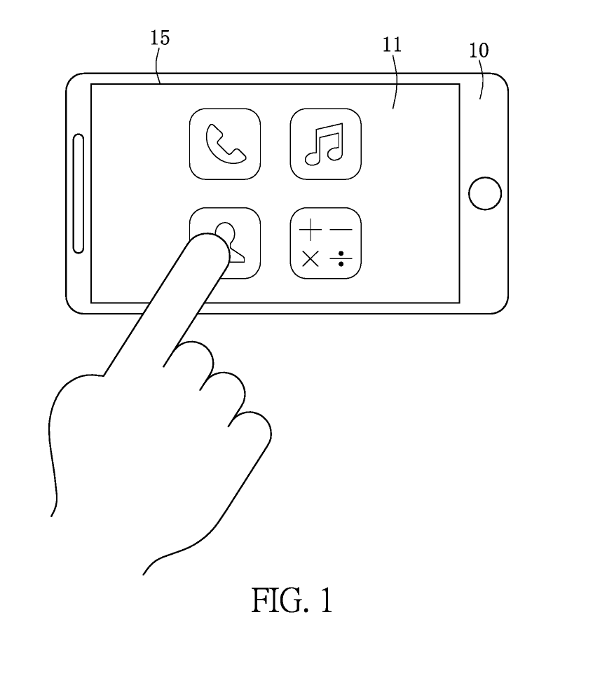

Referring to FIG. 1, FIG. 1 is a schematic diagram of an electronic device according to one embodiment of the present invention. In FIG. 1, the electronic device 10 includes a sensing device 11 and a display unit 15. In this embodiment of the present invention, the sensing device 11 is implemented as a capacitive sensing device. In one case, the sensing device 11 may be used to sense capacitance variation if a conductor, such as a human finger, touches the sensing device 11. In another case, the touch sensing device 11 may be used to sense capacitance variation if a force is applied to a surface of the sensing device 11. The controller (not shown) of the sensing device 11 can determine the touch position and/or applied force from the change in the capacitance measured, to achieve the purpose of making selections, moving a cursor or activating a command by touching or pressing the sensing device 11. Below the term touch event indicates both the touch and force input applied to the sensing device 11.

In one embodiment of the present invention, the sensing device 11 is a resistive sensing device.

However, changes in the environment, such as temperature, humidity or atmospheric pressure, can affect sensitivity of the touch pad, thus reducing the stability of the touch pad. The present invention sets at least one fake sensor to compensate for the influence of environmental changes. The details are described in the following descriptions.

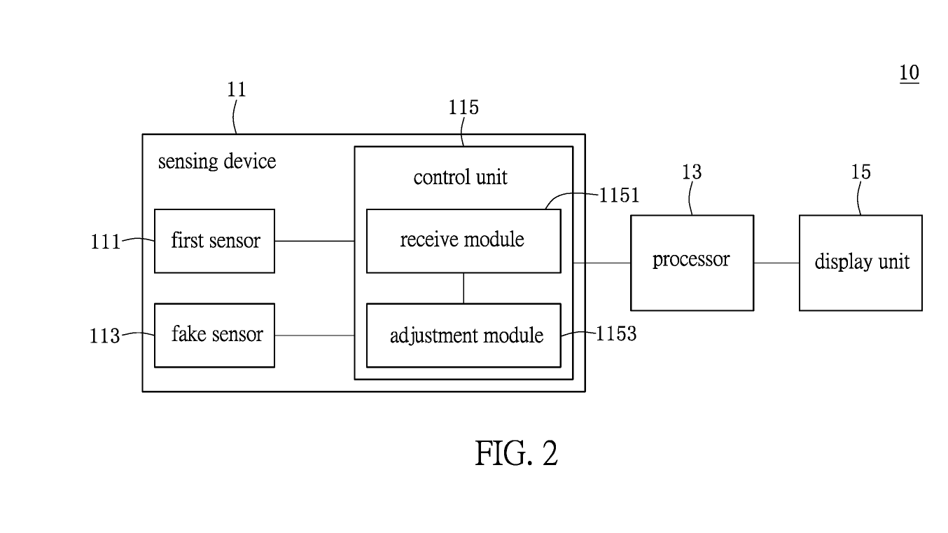

Referring to FIG. 2 and FIG. 1, FIG. 2 is a block diagram of an electronic device according to one embodiment of the present invention. In FIG. 2, the electronic device 10 includes a sensing device 11, a processor 13 and a display unit 15, wherein the sensing device 11 includes a first sensor 111, a fake sensor 113 and a control unit 115. The control unit 115 includes a receive module 1151 and an adjustment module 1153.

The control unit 115 is coupled to the processor 13, and the processor 13 is coupled to the display unit 15. The first sensor 111 and the fake sensor 113 are both coupled to the control unit 115. The receive module 1151 is coupled to the adjustment module 1153.

In this embodiment of the present invention, the sensing device 11 is implemented as a capacitive sensing device. The first sensor 111 detects a touch event and generates a first sensing signal corresponding to the applied touch/force and the environmental changes, and sends the first sensing signal to the control unit 115, wherein the environmental changes could be the change of temperature, humidity or atmospheric pressure, to which the present invention is not limited. Meanwhile, the fake sensor 113 generates a second sensing signal only corresponding to the environmental changes, and sends the second sensing signal to the control unit 115.

The receive module 1151 of the control unit 115 receives the first sensing signal and the second sensing signal and sends them to the adjustment module 1153. The adjustment module 1153 compensates the first sensing signal for the environmental changes by using the second sensing signal and generates a compensated signal only corresponding to the applied touch event as the output signal, wherein the environmental influence in the first sensing signal is removed and the signal of the touch event is preserved in the compensated signal. Then the control unit 115 outputs the compensated signal to the processor 13, and the processor 13 processes and executes the functions corresponding to the applied touch/force without the environmental influence. The processor 13 could, for example, send corresponding data or images to the display unit 15 to display.

In one embodiment of the present invention, for example, the adjustment module 1153 of the control unit 115 compensates the first sensing signal by subtracting the second sensing signal to generate the compensated signal. The first sensing signal could be comprised of a touching signal and an environmental signal, where the touching signal is corresponding to the touch event with applied touch/force and the environmental signal is corresponding to the environmental changes. The second sensing signal could be comprised of only the environmental signal. Therefore, the control unit 115 compensates the first sensing signal by subtracting the second sensing signal to remove the environmental signal and preserve the touching signal. Thus, the compensated signal without the environmental influence is obtained by directly subtracting the second sensing signal. The touching signal could be a kind of delta function and the environmental signal could be also a kind of delta function, to which the present invention is not limited.

In one embodiment of the present invention, the fake sensor 113 is placed in a position not in contact with the applied touch/force. For example, the fake sensor 113 could be placed further away from the first sensor 111, or the fake sensor 113 could be placed on the other side of the sensing device 11 relative to the touching side. In the embodiment of pressure sensing, the fake sensor 113 may be protected by a shield to prevent the surface of the fake sensor 113 been pressed by external force. Accordingly, the fake sensor 113 can generate the second sensing signal only corresponding to the environmental changes.

The present invention does not limit the shape, type or distribution of the sensing device 11. For example, the sensing device 11 could be a surface capacitive touch panel, a projected capacitive touch panel or a deformable capacitive pressure sensing device. The present invention also does not limit the shape, arrangement or distribution of the first sensor 111 and the fake sensor 113.

In one embodiment of the present invention, the first sensor 111 and the fake sensor 113 have the same circuit properties.

In one embodiment of the present invention, the first sensor 111 and the fake sensor 113 belong to the same sensor array.

In one embodiment of the present invention, the fake sensor 113 is independent of the sensor array of the first sensor 111.

In one embodiment of the present invention, the electronic device 10 is a tablet computer, a smart phone, a smart watch or a monitor, to which the present invention is not limited.

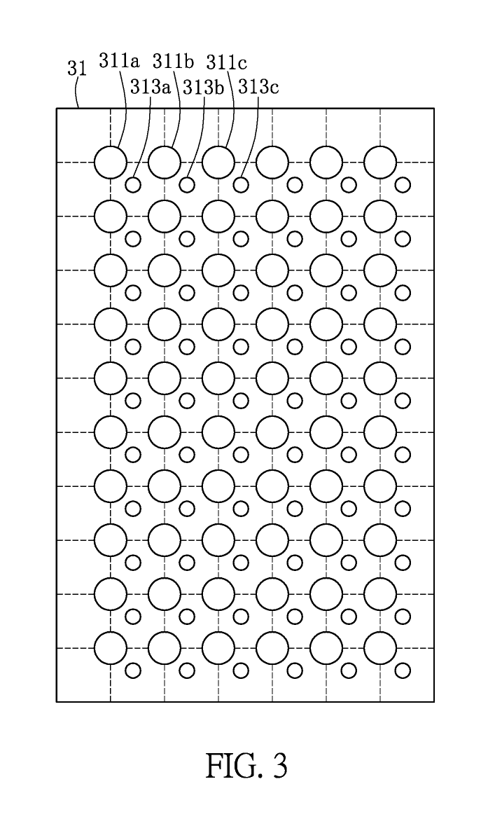

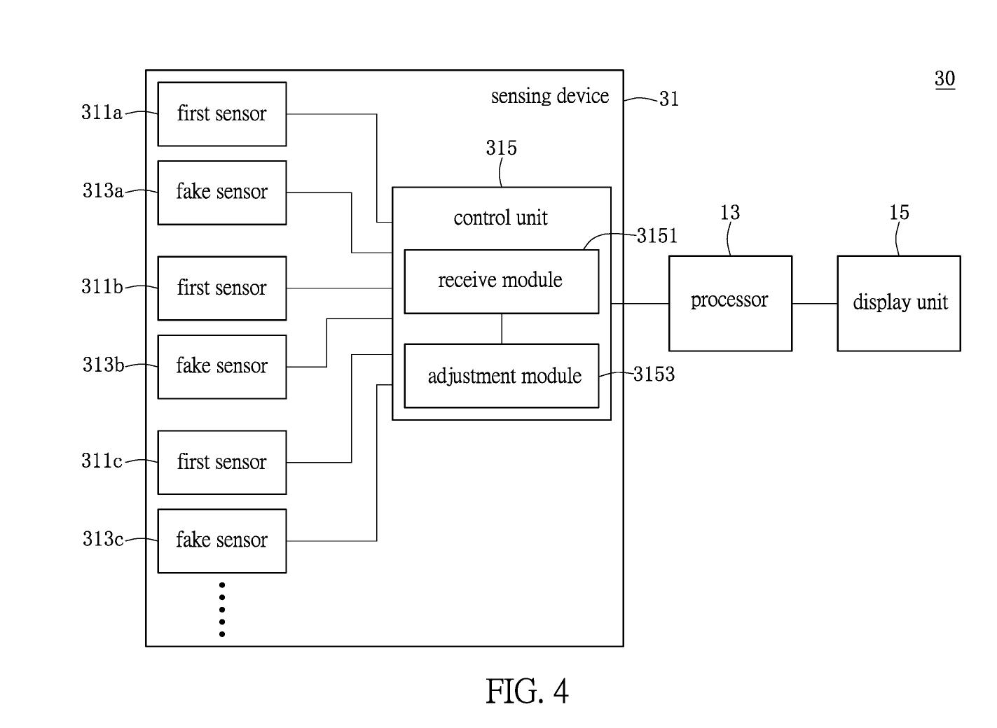

Referring to FIG. 3 and FIG. 4, FIG. 3 is a schematic diagram of a sensing device according to another embodiment of the present invention and FIG. 4 is a block diagram of an electronic device according to another embodiment of the present invention. The electronic device 30 includes a sensing device 31, a processor 13 and a display unit 15, wherein the sensing device 31 includes a plurality of first sensors 311a, 311b, 311c, etc., a plurality of fake sensors 313a, 313b, 3 13c, etc. and a control unit 315. The control unit 315 includes a receive module 3151 and an adjustment module 3153.

The control unit 315 is coupled to the processor 13, and the processor 13 is coupled to the display unit 15. The first sensors 311a, 311b, 311c, etc. and the fake sensors 3 13a, 313b, 313c, etc. are coupled to the control unit 315. The receive module 3151 is coupled to the adjustment module 3153.

The present embodiment is different from the embodiment in FIG. 1 and FIG. 2 in that the sensing device 31 of the present embodiment includes a plurality of first sensors and a plurality of fake sensors, wherein each first sensor is adjacent to a fake sensor.

In this embodiment of the present invention, the sensing device 31 is implemented as a capacitive sensing device. The first sensor 311a detects the touch event and generates a first sensing signal corresponding to the applied touch/force and the environmental changes, and sends the first sensing signal to the control unit 315. Meanwhile, the fake sensor 313a adjacent to the first sensor 311a generates a second sensing signal only corresponding to the environmental changes, and sends the second sensing signal to the control unit 315. Then the adjustment module 3153 compensates the first sensing signal for the environmental changes by using the second sensing signal and generates a compensated signal only corresponding to the applied touch/force as the output signal.

The fake sensor 313a is placed in the position adjacent to the first sensor 311a, but not in contact with the applied touch/force. Accordingly, the fake sensor 313a can generate a second sensing signal only corresponding to the environmental changes.

Similarly, when a touch event applied to the first sensor 311b of the sensing device 31, the adjustment module 3153 compensates the first sensing signal generated by the first sensor 311b for the environmental changes by using the second sensing signal generated by the fake sensor 313b adjacent to the first sensor 311b and generates a compensated signal only corresponding to the applied touch event as the output signal.

Therefore, by setting a plurality of first sensors and a plurality of fake sensors, each first sensor is adjacent to each fake sensor. The control unit 315 compensates the first sensing signal generated by the first sensor been applied by the touch event for the environmental changes by subtracting the second sensing signal generated by the corresponding fake sensor to remove the environmental signal and preserve the touching signal, thereby ensuring the stability of the sensing device operation in various environments.

The present invention does not limit the shape, arrangement or distribution of the first sensors 311a, 311b, 311c, etc. and the fake sensors 313a, 313b, 313c, etc.

In one embodiment of the present invention, the first sensor 311a, 311b, 311c, etc. and the fake sensor 313a, 313b, 313c, etc. have the same circuit properties.

In one embodiment of the present invention, the first sensor 311a, 311b, 311c, etc. and the fake sensor 313a, 313b, 313c, etc. belong to the same sensor array.

In one embodiment of the present invention, the fake sensors 313a, 313b, 313c, etc. are independent of the sensor array of the first sensors 311a, 311b, 311c, etc.

In one embodiment of the present invention, the sensing device 31 is a resistive sensing device, and the control unit 315 is a resistive sensing control unit.

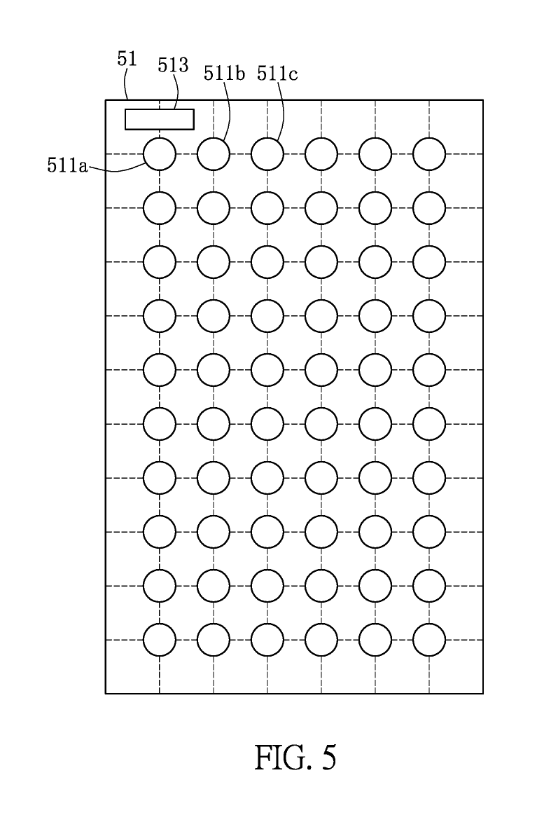

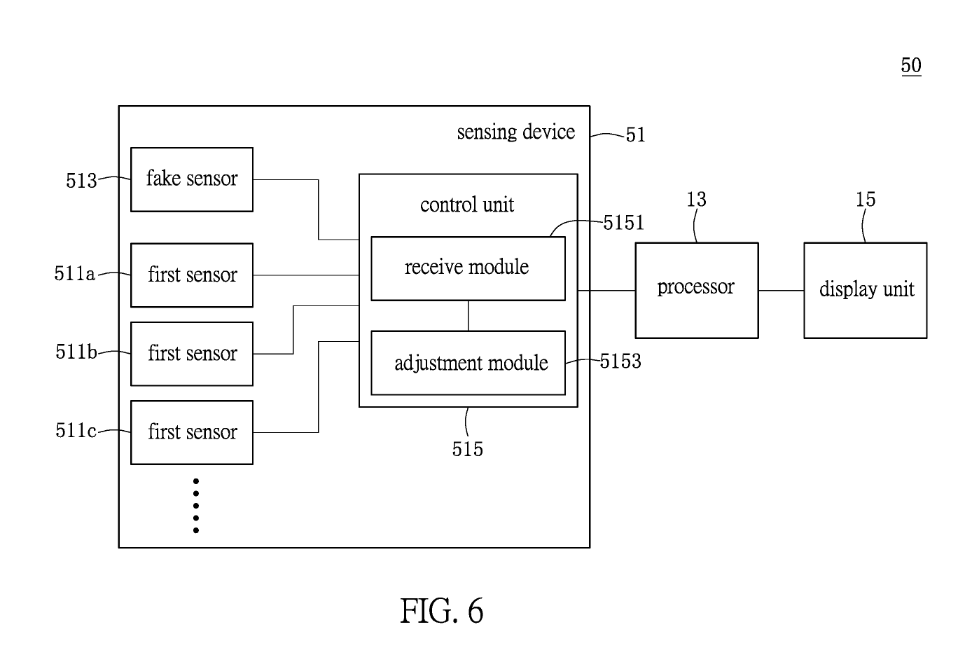

Referring to FIG. 5 and FIG. 6, FIG. 5 is a schematic diagram of a sensing device according to still another embodiment of the present invention and FIG. 6 is a block diagram of an electronic device according to still another embodiment of the present invention. The electronic device 50 includes a sensing device 51, a processor 13 and a display unit 15, wherein the sensing device 51 includes a plurality of first sensors 511a, 511b, 511c, etc., a fake sensor 513 and a control unit 515. The control unit 515 includes a receive module 5151 and an adjustment module 5153.

The control unit 515 is coupled to the processor 13, the processor 13 is coupled to the display unit 15. The first sensors 511a, 511b, 511c, etc. and the fake sensor 513 are coupled to the control unit 515. The receive module 5151 is coupled to the adjustment module 5153.

The present embodiment is different from the embodiment in FIG. 1 and FIG. 2 in that the sensing device 51 of the present embodiment includes a plurality of first sensors.

In this embodiment of the present invention, the sensing device 51 is implemented as a capacitive sensing device. The first sensor 511a detects the touch event and generates a first sensing signal corresponding to the applied touch/force and the environmental changes, and sends the first sensing signal to the control unit 515. Meanwhile, the fake sensor 513 generates a second sensing signal only corresponding to the environmental changes, and sends the second sensing signal to the control unit 515. Then the adjustment module 5153 compensates the first sensing signal for the environmental changes by using the second sensing signal and generates a compensated signal only corresponding to the applied touch event as the output signal.

The sensing device 51 can include more than one fake sensor 513, however, each fake sensor 513 can provide a second sensing signal for compensation to a plurality of first sensors. Each fake sensor 513 can provide second sensing signal corresponding to the environmental changes, therefore can be used to compensate a plurality of first sensing signals from first sensors near the fake sensor.

Similarly, when a touch event applied to the first sensor 511b of the sensing device 51, the adjustment module 5153 compensates the first sensing signal generated by the first sensor 511b for the environmental changes by using the second sensing signal generated by the fake sensor 513 and generates a compensated signal only corresponding to the applied touch event as the output signal.

Therefore, by setting a plurality of first sensors and at least one fake sensor, the control unit 515 compensates the first sensing signal generated by the first sensor been applied by the touch event for the environmental changes by subtracting the second sensing signal generated by the fake sensor near the first sensor been applied by the touch event to remove the environmental signal and preserve the touching signal, thereby ensuring the stability of the sensing device operation in various environments. For example, the fake sensor can be used to compensate first sensing signals from first sensors near the fake sensor in a predetermined distance.

The present invention does not limit the shape, arrangement or distribution of the first sensors 511a, 511b, 511c, etc. and the fake sensor 513.

In one embodiment of the present invention, the first sensor 511a, 511b, 511c, etc. and the fake sensor 513 have the same circuit properties.

In one embodiment of the present invention, the first sensor 511a, 511b, 511c, etc. and the fake sensor 513 belong to the same sensor array.

In one embodiment of the present invention, the fake sensor 513 is independent of the sensor array of the first sensor 511a, 511b, 511c, etc.

In one embodiment of the present invention, the sensing device 51 is a resistive sensing device, and the control unit 515 is a resistive sensing control unit.

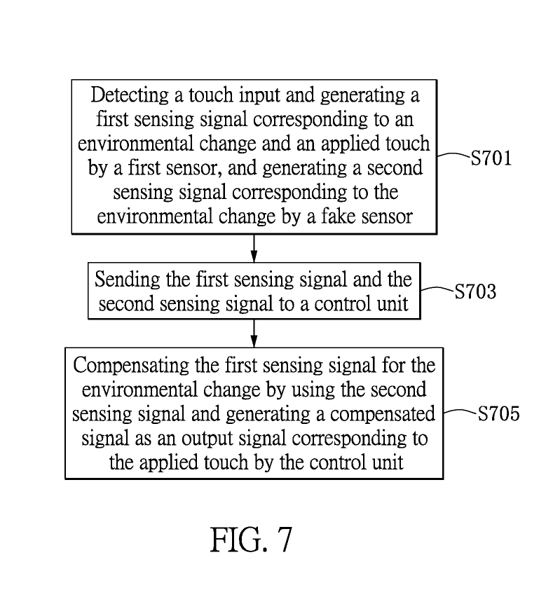

Referring to FIG. 7 and FIG. 2, FIG. 7 is a flowchart of a method for controlling a sensing device according to one embodiment of the present invention. In step S701, the first sensor 111 detects the touch event and generates a first sensing signal corresponding to the applied touch event and the environmental changes. Meanwhile, the fake sensor 113 generates a second sensing signal only corresponding to the environmental changes. In step S703, the first sensor 111 sends the first sensing signal to the control unit 115 and the fake sensor 113 sends the second sensing signal to the control unit 115. In step S705, the receive module 1151 of the control unit 115 receives the first sensing signal and the second sensing signal and sends them to the adjustment module 1153. The adjustment module 1153 compensates the first sensing signal for the environmental changes by using the second sensing signal and generates a compensated signal only corresponding to the applied touch event as the output signal, wherein the environmental influence in the first sensing signal is removed and the signal of the touch event is preserved in the compensated signal.

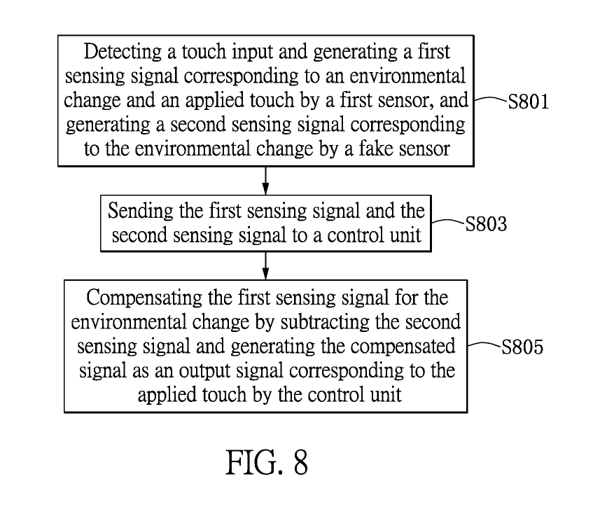

Referring to FIG. 8 and FIG. 2, FIG. 8 is a flowchart of a method for controlling a touch sensing device according to another embodiment of the present invention. In step S801, the first sensor 111 detects the touch event and generates a first sensing signal corresponding to the applied touch event and the environmental changes. Meanwhile, the fake sensor 113 generates a second sensing signal only corresponding to the environmental changes. In step S803, the first sensor 111 sends the first sensing signal to the control unit 115 and the fake sensor 113 sends the second sensing signal to the control unit 115. In step S805, the receive module 1151 of the control unit 115 receives the first sensing signal and the second sensing signal and sends them to the adjustment module 1153. The adjustment module 1153 compensates the first sensing signal for the environmental changes by subtracting the second sensing signal to generate a compensated signal only corresponding to the applied touch event as the output signal, wherein the environmental influence in the first sensing signal is removed and the signal of the touch event is preserved in the compensated signal.

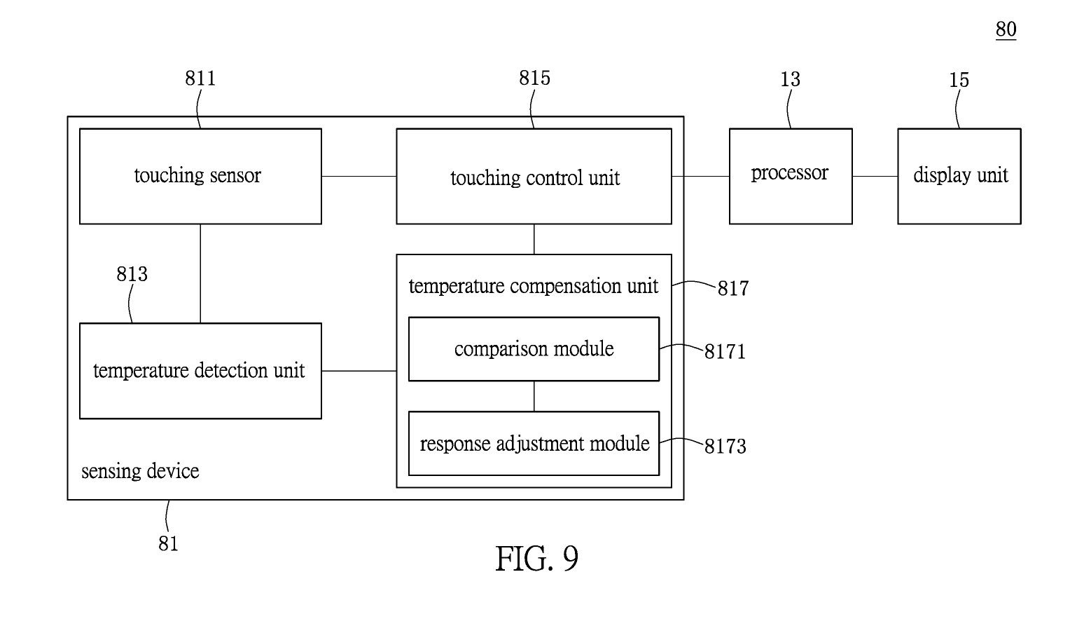

Referring to FIG. 9, FIG. 9 is a block diagram of an electronic device according to still another embodiment of the present invention. In FIG. 9, the electronic device 80 includes a sensing device 81, a processor 13 and a display unit 15, wherein the sensing device 81 includes a touching sensor 811, a temperature detection unit 813, a touching control unit 815 and a temperature compensation unit 817. The temperature compensation unit 817 includes a comparison module 8171 and a response adjustment module 8173.

The touching control unit 815 is coupled to the processor 13, and the processor 13 is coupled to the display unit 15. The touching sensor 811 is coupled to the touching control unit 815 and the temperature detection unit 813. The temperature compensation unit 817 is coupled to the touching control unit 815 and the temperature detection unit 813. The comparison module 8171 is coupled to the response adjustment module 8173.

In this embodiment of the present invention, the touching sensor 811 is implemented as a capacitive sensing sensor. The touching sensor 811 detects the touch event and generates a touch sensing signal corresponding to the applied touch event and the temperature change, and sends the touch sensing signal to the touching control unit 815. Meanwhile, the temperature detection unit 813 measures the temperature of the touch sensing device 81 and generating a temperature value, and sends the temperature value to the temperature compensation unit 817. The comparison module 8171 of the temperature compensation unit 817 receives the temperature value, and the response adjustment module 8173 generates a background response value corresponding to the temperature value. The background response value is the background response of the touching sensor 811 at the temperature.

The response adjustment module 8173 then generates a background response control signal including the background response value and sends the background response control signal to the touching control unit 815. The touching control unit 815 adjusts the touch sensing signal according to the background response control signal to remove the influence of temperature. For example, the touching control unit 815 can adjust the touch sensing signal by subtracting the background response value to remove the influence of temperature.

The temperature influence in the touch sensing signal is removed and the signal of the touch event is preserved in the adjusted signal. Then the touching control unit 815 outputs the adjusted signal to the processor 13, and the processor 13 processes and executes the functions corresponding to the applied touch event without the temperature influence. The processor 13 could, for example, send corresponding data or images to the display unit 15 to display.

In one embodiment of the present invention, the comparison module 8171 receives the temperature value and analyzes the variation of the temperature value, if the variation of the temperature value exceeds a predetermined threshold, the response adjustment module 8173 resets the background response value of the background response control signal to a default background response value, wherein the default background response value is the background response when the touching sensor 811 not been applied by the touch event at the temperature value.

In one embodiment of the present invention, the touching sensor 811 is a resistive sensing sensor, and the touching control unit 815 is a resistive sensing control unit.

In one embodiment of the present invention, the electronic device 80 is a tablet computer, a smart phone, a smart watch or a monitor, to which the present invention is not limited.

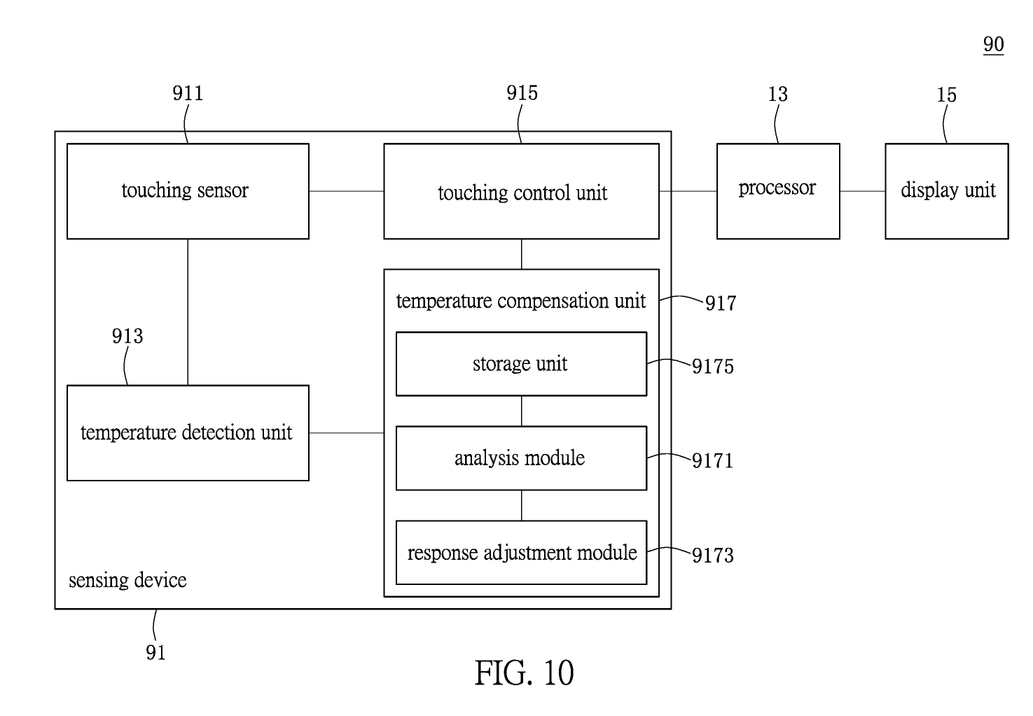

Referring to FIG. 10, FIG. 10 is a block diagram of an electronic device according to still another embodiment of the present invention. In FIG. 10, the electronic device 90 includes a touch sensing device 91, a processor 13 and a display unit 15, wherein the touch sensing device 91 includes a touching sensor 911, a temperature detection unit 913, a touching control unit 915 and a temperature compensation unit 917. The temperature compensation unit 917 includes a storage unit 9175, an analysis module 9171 and a response adjustment module 9173.

The touching control unit 915 is coupled to the processor 13, and the processor 13 is coupled to the display unit 15. The touching sensor 911 is coupled to the touching control unit 915 and the temperature detection unit 913. The temperature compensation unit 917 is coupled to the touching control unit 915 and the temperature detection unit 913. The analysis module 9171 is coupled to the storage unit 9175 and the response adjustment module 9173.

In this embodiment of the present invention, the touching sensor 911 is implemented as a capacitive sensing sensor. The touching sensor 911 detects the touch event and generates a touch sensing signal corresponding to the applied force and the temperature change, and sends the touch sensing signal to the touching control unit 915. Meanwhile, the temperature detection unit 913 measures the temperature of the touch sensing device 91 and generating a temperature value, and sends the temperature value to the temperature compensation unit 917.

The storage unit 9175 stores a plurality of background response values corresponding to different temperature values, wherein the background response value is the background response of the touching sensor 911 at the specific temperature. The analysis module 9171 receives the temperature value, and searches the storage unit 9175 to obtain the background response value corresponding to the temperature value. The analysis module 9171 sends the background response value to the response adjustment module 9173, and the response adjustment module 9173 generates the background response control signal including the background response value and sends the background response control signal to the touching control unit 915.

The touching control unit 915 adjusts the touch sensing signal according to the background response control signal to remove the influence of temperature. For example, the touching control unit 915 can adjust the touch sensing signal by subtracting the background response value to remove the influence of temperature.

The temperature influence in the touch sensing signal is removed and the signal of the touch event is preserved in the adjusted signal. Then the touching control unit 915 outputs the adjusted signal to the processor 13, and the processor 13 processes and executes the functions corresponding to the applied touch event without the temperature influence. The processor 13 could, for example, send corresponding data or images to the display unit 15 to display.

In one embodiment of the present invention, the touching sensor 911 is a resistive sensing sensor, and the touching control unit 915 is a resistive sensing control unit.

The descriptions illustrated supra set forth simply the preferred embodiments of the present invention; however, the characteristics of the present invention are by no means restricted thereto. All changes, alterations, or modifications conveniently considered by those skilled in the art are deemed to be encompassed within the scope of the present invention delineated by the following claims.

What is claimed is:

1. A touch sensing device, comprising:
a control unit;
at least one first sensor coupled to the control unit, the first sensor configured for detecting a touch event and generating a first sensing signal corresponding to an environmental change and the touch event applied, and sending the first sensing signal to the control unit; and
at least one fake sensor coupled to the control unit, the fake sensor configured for generating a second sensing signal corresponding to the environmental change, and sending the second sensing signal to the control unit;
wherein the control unit compensates the first sensing signal for the environmental change by using the second sensing signal and generates a compensated signal as an output signal corresponding to the touch event applied.

2. The touch sensing device according to claim 1, wherein the control unit is a capacitive sensing control unit or a resistive sensing control unit.

3. The touch sensing device according to claim 1, wherein the first sensor and the fake sensor have the same circuit properties.

4. The touch sensing device according to claim 1, wherein the first sensor and the fake sensor belong to the same sensor array.

5. The touch sensing device according to claim 1, wherein the fake sensor is independent of the sensor array of the first sensor.

6. The touch sensing device according to claim 1, wherein the control unit compensates the first sensing signal for the environmental change by subtracting the second sensing signal and generates the compensated signal.

7. The touch sensing device according to claim 1, wherein the touch event applied is a pressure applied to the touch sensing device.

8. The touch sensing device according to claim 1, wherein the control unit comprises a receive module and an adjustment module, the receive module is coupled to the adjustment module, the receive module receives the first sensing signal and the second sensing signal and sends them to the adjustment module, and the adjustment module compensates the first sensing signal for the environmental change by using the second sensing signal and generates the compensated signal as the output signal corresponding to the touch event applied.

9. The touch sensing device according to claim 1, wherein the first sensing signal is comprised of a touching signal and an environmental signal, wherein the touching signal is corresponding to the touch event applied and the environmental signal is corresponding to the environmental change.

10. The touch sensing device according to claim 9, wherein the second sensing signal is comprised of the environmental signal.

11. The touch sensing device according to claim 9, wherein the touching signal is a delta function.

12. The touch sensing device according to claim 9, wherein the environmental signal is a delta function.

13. The touch sensing device according to claim 1, wherein the environmental change is the change of temperature, humidity or atmospheric pressure.

14. The touch sensing device according to claim 1, wherein the touch sensing device is a tablet computer, a smart phone, a smart watch or a monitor.

15. A method for controlling a touch sensing device, comprising:
detecting a touch event and generating a first sensing signal corresponding to an environmental change and the touch event applied by a first sensor;
sending the first sensing signal to a control unit;
generating a second sensing signal corresponding to the environmental change by a fake sensor;
sending the second sensing signal to the control unit; and
compensating the first sensing signal for the environmental change by the second sensing signal and generating a compensated signal as an output signal corresponding to the touch event applied by the control unit.

16. The method for controlling a touch sensing device according to claim 15, wherein the control unit is a capacitive sensing control unit or a resistive sensing control unit.

17. The method for controlling a touch sensing device according to claim 15, wherein the first sensor and the fake sensor have the same circuit properties.

18. The method for controlling a touch sensing device according to claim 15, wherein the first sensor and the fake sensor belong to the same sensor array.

19. The method for controlling a touch sensing device according to claim 15, wherein the fake sensor is independent of the sensor array of the first sensor.

20. The method for controlling a touch sensing device according to claim 15, wherein the control unit compensates the first sensing signal for the environmental change by subtracting the second sensing signal and generates the compensated signal.

21. The method for controlling a touch sensing device according to claim 15, wherein the touch event applied is a pressure applied to the touch sensing device.

22. The method for controlling a touch sensing device according to claim 15, wherein the control unit comprises a receive module and an adjustment module, the receive module is coupled to the adjustment module, the receive module receives the first sensing signal and the second sensing signal and sends them to the adjustment module, the adjustment module compensates the first sensing signal for the environmental change by using the second sensing signal and generates the compensated signal as the output signal corresponding to the touch event applied.

23. The method for controlling a touch sensing device according to claim 15, wherein the first sensing signal is comprised of a touching signal and an environmental signal, wherein the touching signal is corresponding to the touch event applied and the environmental signal is corresponding to the environmental change.

24. The method for controlling a touch sensing device according to claim 23, wherein the second sensing signal is comprised of the environmental signal.

25. A touch sensing device, comprising:
a touching control unit;
a touching sensor coupled to the touching control unit, the touching sensor configured for detecting a touch event and generating a touch sensing signal, and sending the touch sensing signal to the touching control unit;
a temperature compensation unit coupled to the touching control unit; and
a temperature detection unit coupled to the temperature compensation unit, the temperature detection unit configured for measuring the temperature of the touch sensing device and generating a temperature value, and sending the temperature value to the temperature compensation unit;
wherein the temperature compensation unit generates a background response control signal corresponding to the temperature value and sends the background response control signal to the touching control unit, and the touching control unit adjusts the touch sensing signal according to the background response control signal.

26. The touch sensing device according to claim 25, wherein the touching control unit is a capacitive sensing control unit or a resistive sensing control unit.

27. The touch sensing device of claim 25, wherein the background response control signal includes a background response value, and the touching control unit adjusts the touch sensing signal by subtracting the background response value.

28. The touch sensing device of claim 27, wherein the temperature compensation unit comprises a comparison module and a response adjustment module, the comparison module coupled to the response adjustment module, the comparison module receives the temperature value and analyzes the variation of the temperature value, and if the variation of the temperature value exceeds a predetermined threshold, the response adjustment module resets the background response value of the background response control signal to a default background response value, wherein the default background response value is the background response when the touching sensor hasn't been touched at the temperature value.

29. The touch sensing device of claim 27, wherein the temperature compensation unit further comprises a storage unit, the storage unit stores a plurality of background response values corresponding to different temperature values, and the temperature compensation unit generates the background response control signal corresponding to the temperature value according to the data of the storage unit.

30. The touch sensing device of claim 29, wherein the temperature compensation unit further comprises an analysis module and a response adjustment module, the analysis module coupled to the response adjustment module and the storage unit, the analysis module receives the temperature value, searches the storage unit to obtain the background response value corresponding to the temperature value, and sends the background response value to the response adjustment module, and the response adjustment module generates the background response control signal according to the background response value and sends the background response control signal to the touching control unit.
